(19) United States
(12) Patent Application Publication
(10) Pub. No.: US 2017/0079479 A1
(43) Pub. Date: Mar. 23, 2017

(54) Thermally Conductive Agitator for Shaker Cup

(71) Applicant: Exemplar Design, LLC, Mason, OH (US)

(72) Inventors: Adam L. Ross, Mason, OH (US); Marc J. Crosby, Manhattan Beach, CA (US)

(73) Assignee: Exemplar Design, LLC, Mason, OH (US)

(21) Appl. No.: 15/266,742

(22) Filed: Sep. 15, 2016

Related U.S. Application Data
(60) Provisional application No. 62/220,324, filed on Sep. 18, 2015.

(51) Int. Cl. A47J 43/27; B01F 15/06; B01F 13/00

(52) U.S. Cl. CPC A47J 43/27; B01F 13/005; B01F 15/066; B01F 13/0022; B01F 2215/0022

(57) ABSTRACT

A mixing cup for mixing liquid beverages including an agitator having a hollow chamber therein for receiving a thermal material such that when a beverage is mixed in the mixing cup the agitator imparts a thermal change to the beverage making the beverage either hotter or cooler depending on the temperature of the agitator.

This application claims priority to provisional patent application No. 62/220,324 filed with the United States Patent & Trademark Office on Sep. 18, 2015, the entire content of which is hereby incorporated by reference.

### TECHNICAL FIELD

The present disclosure relates generally to cups for mixing different liquid substances therein, and more specifically, to such cups which include a thermally conductive agitator therein which can be used to cool and/or heat the mixed liquid.

### BACKGROUND

Drinking vessels with independent agitators have been designed for mixing powdered solids, such as protein powders or diet supplements, with liquids. Typically, these designs and methods are used in the preparation of consumable liquids formulated to support health or enhance athletic performance. The powders/solids are typically placed inside the cup/shaker with a liquid (often milk, water, or other consumable substance) and the cup or other vessel is shaken. The agitator assists in evenly dispersing and blending the solid particles with the liquid.

At least one example of such a cup/agitator combination is disclosed in U.S. application Ser. No. 14/184,773. That application discloses a shaker including a vessel and an agitator. The vessel includes a container wall. A rounded bottom closes off the container wall, wherein a border of the bottom is formed radially towards a center axis of the vessel such that the bottom transitions from the container wall to be outwardly domed. A tetrahedral agitator is disclosed in connection with the shaker cup disclosed in that application.

Similarly, U.S. Pat. No. 6,379,032 shows a wire-frame, flow-through agitator. See also U.S. D664,392 which discloses a similar mixing element of the wire-type, formed conically. In some cases, the agitator element may be integrated into the cup design (See, e.g., U.S. Pat. No. 7,441,941).

However, despite the foregoing (and other) prior art that discloses various shaker cups/agitators for use in mixing liquids with powders (or other liquids), there are no prior art designs disclosing an agitator having the capability of appreciably changing the temperature of the liquid being mixed. Further, none of these prior art shaker cups and/or agitator designs discloses an agitator that can be used to cool and/or heat the liquid being mixed simultaneously with the mixing of the liquid during the mixing process.

### SUMMARY

According to an aspect of the present disclosure, a shaker cup and thermally conductive agitator combination is disclosed having the capability of appreciably affecting the temperature of a liquid being mixed in the shaker cup. Further, in accordance with the disclosure, the thermally conductive agitator has protrusions, fins, blades, etc., i.e. features which increase the agitation function of the agitator more significantly than a smooth ball or cube design.

In accordance with the disclosure, the thermally conductive agitator may include a gel or other known thermal material that is encased in a portion of the agitator (either permanently or removably) that may be heated and/or cooled/frozen prior to use to mix the liquid in order to appreciably change or maintain the temperature of the liquid being mixed.

In another aspect of the disclosure, the thermally conductive agitator may include a hollow chamber having a liquid-tight removable cap or enclosure thereon. In such an embodiment, the cap may be removed by a user and the chamber filled with water (or another liquid) and thereafter frozen. In accordance with embodiments where a heated beverage is desired, the chamber may be filled with a liquid that is already heated or that is heated after filling.

In accordance with the foregoing embodiments, the design of the thermally conductive agitator protrusions, fins, blades, etc. may increase the dispersion of heat or absorption of heat from the beverage being mixed. Further, as is known in the art, the actual mixing of the substance through shaking may also improve the dispersion of heat or absorption of heat by the thermally conductive agitator, and more particularly, the thermal material encased, enclosed or removably contained therein.

### BRIEF DESCRIPTION OF THE DRAWINGS

FIG. 1 is a side perspective view of a shaker cup for use in accordance with aspects of the present disclosure;

FIG. 2 is a side perspective view of three separate thermally conductive agitator designs operable in connection with aspects of the present disclosure;

FIG. 3 is a top perspective view of the agitators of FIG. 2;

FIG. 4. is a side perspective view of a thermal gel pack operable for use in connection with the thermally conductive agitators of the present disclosure;

FIG. 5 is a side perspective view of one of the agitators of FIG. 2 showing the cap removed to allow for addition or removal of the thermal material such as the gel pack shown in FIG. 4; and

FIG. 6 is a side perspective view of an agitator having a hollow chamber and removable cap in accordance with aspects of the disclosure.

### DETAILED DESCRIPTION

In accordance with the foregoing, a thermally conductive agitator for use in connection with a shaker cup is disclosed. The combination agitator/shaker cup is an improvement over prior art agitator/shaker cup designs that do not provide a way for a user thereof to either add or remove heat to the liquid beverages being mixed in the shaker cup. Further, as opposed to the use of ice cubes, the use of the agitator of the present disclosure does not dilute the liquid beverage being mixed in order to cool the mixture.

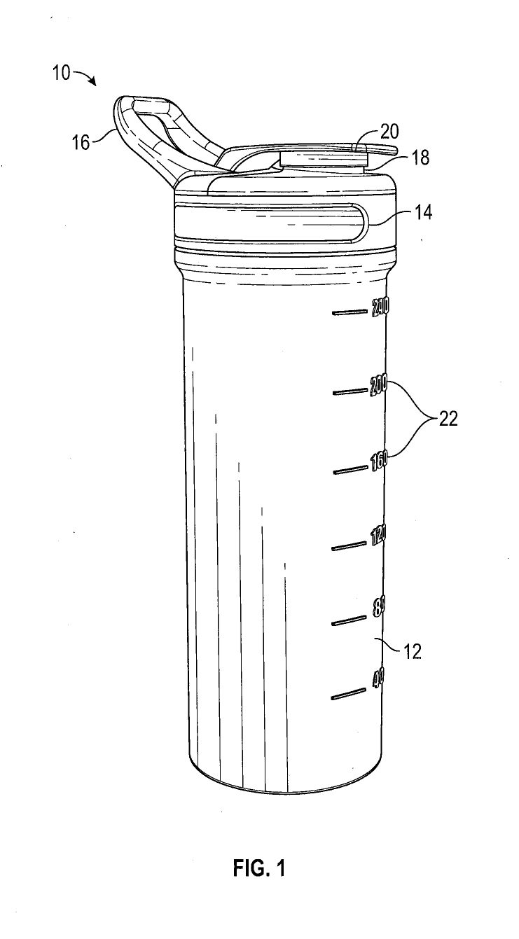

As shown in FIG. 1, the present disclosure may include a shaker cup 10 of conventional design having a body 12 and lid 14. The lid 14 may be held to the body in a conventional manner, including threads, snaps, etc. The lid 14 may include a handle 16 and a spout 18 having a cover 20 therefor. The body 12 of the cup 10 may be made of known materials, may be clear, opaque, or solid, and may include volume gradations 22 thereon.

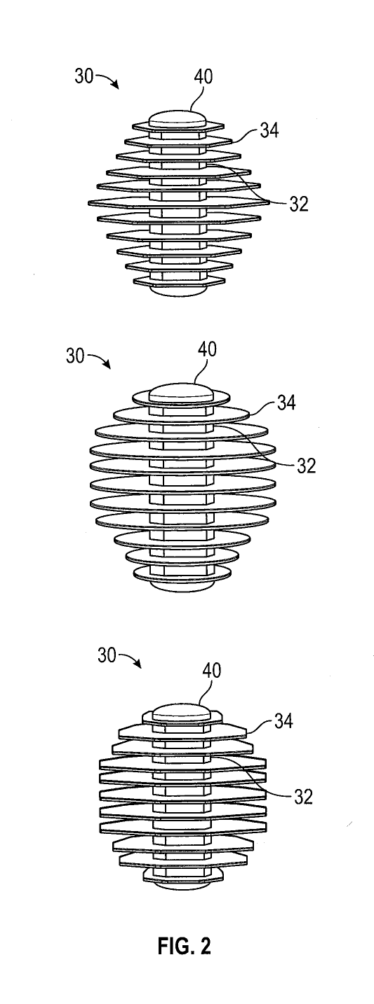

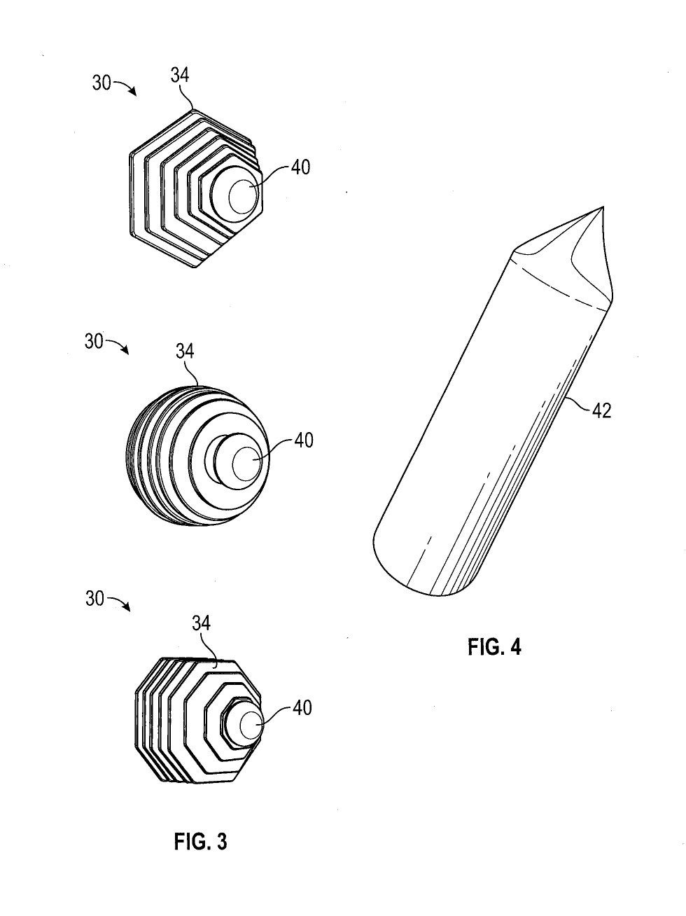

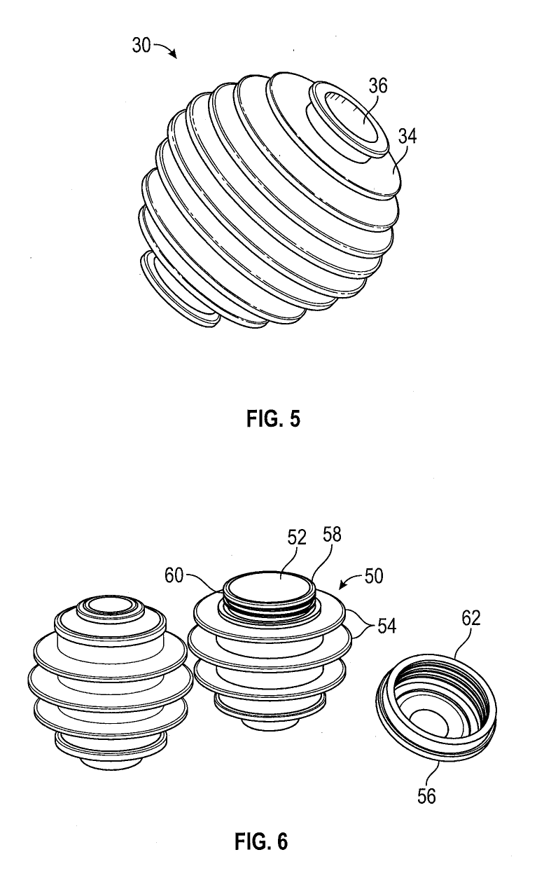

As shown best in FIGS. 2 and 3, the present disclosure provides a thermally conductive agitator 30. While the thermally conductive agitator 30 of the present disclosure may be of any kind of suitable structure (and preferably include a protrusion, fin, blade, etc. for aiding in thermal distribution and agitation functions), the agitators 30 disclosed herein include a main body 32 having a cavity 36 (shown in FIG. 5) therein for receiving a thermal material and fins 34 attached thereto. In some embodiments, a removable cap 40 may be provided. The shape of the fins 34 may be circular, tetrahedral, trapezoidal, or any other suitable shape. The agitator 30 may be made of any suitable thermally conductive material including plastic, metals, ceramics, etc. as well as a combination of materials.

As shown best in FIGS. 4 and 5, in one embodiment of the disclosure, the thermal material may be provided in the form of a removable pack 42 shaped and sized to fit in the cavity 36 of the agitator 30. The pack 42 may be sealed in the cavity 36 by the cap 40. In another embodiment, and in accordance with the disclosure, the thermal material may be permanently sealed in the agitator 30. In yet another embodiment, the entirety of, or portions of, the agitator 30 may be entirely comprised of thermal material.

As shown best in FIG. 6, in another embodiment of the disclosure, an agitator 50 may be comprised of a hollow chamber 52, at least one fin 54, and a cap 56. In such an embodiment, the hollow chamber 52 may be shaped and sized to receive a volume of thermal liquid, such as water, sealingly therein. The chamber 52 may include a neck 58 having threads thereon 60 shaped to mate with and provide a liquid tight closure with corresponding threads 62 on an inner portion of the cap 56.

As will be clear to a person of ordinary skill in the art, the exact form, shape and structure of the disclosure may be modified without departing from the invention disclosed. For example, the shape of the thermally conductive agitator 30 can be varied as long as some aspect is provided which contributes to thermal conductivity and/or agitation functions. A multitude of materials may be used for the agitators 30, 50 and shaker cup 10 to achieve the desired functionality as would be known in the art. Non-limiting examples of acceptable materials include plastic, glass, metal, rubber, etc. Similarly, the thermal material may be of any known composition, including, without limitation, silicone gel, refrigerant gel, water, water mixtures, hydroxyethyl cellulose, silica gel, ammonium nitrate, ammonium chloride, polymers, etc. Consistent with the disclosure, the thermal material may be located anywhere within the agitators 30, 50 that is functionally useful.

The method of use of the shaker cup 10/agitator 30, 50 combination consistent with the disclosure may be as follows. Initially, in the case where water is being used with the agitator 50, water may be added to the hollow chamber 52 and the cap 56 may be screwed onto the neck 58 of the agitator 50 to sealingly hold the water therein. Next, the agitator 30/50 may be cooled (such as by a freezer) or heated (via microwave or other method) depending on whether the user wants to heat or cool the liquid beverage to be mixed in the shaker cup 10. The user may then place the components of the liquid beverage to be mixed in the cup 10, place the agitator 30/50 (once the desired temperature is attained) in the cup 10, and then secure the lid 14 to the body 12 of the cup 10 as is known in the art. The user may then shake the cup 10 to homogenize the contents and impart the desired temperature to the liquid beverage. As would be clear to a person of ordinary skill, the shaker cup 10/agitator 30, 50 combination may be used to heat/cool any number of liquid beverages and even, potentially, emulsions, suspensions and some solid mixtures.

The shaker cup 10/agitator 30, 50 combination of the present disclosure may be fabricated as is known in the art, including but not limited to molding, 3-D printing, milling, etc. The shaker cup 10/agitator 30, 50 may be used in any field, multiple purposes as desired including, but not limited to, fitness, nutrition, medical, construction, industrial, etc. The advantageous technical effects of the present disclosure allow a user to simultaneously mix a liquid beverage thoroughly while changing the thermal properties of the mixture (either hotter or colder than ambient) while not diluting the liquid beverage or otherwise altering its physical characteristics.

It will be appreciated that the foregoing description provides examples of the disclosed apparatus and method. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain functions is intended to indicate a lack of preference for those functions, but not to exclude such from the scope of the disclosure entirely unless otherwise indicated. All methods described herein can be performed in any suitable order unless otherwise indicated herein or otherwise clearly contradicted by context.

I claim:

1. A mixing apparatus comprising:
a mixing cup;
an agitator;
wherein said agitator includes a hollow chamber therein for holding a thermal material associated therewith.

2. The mixing apparatus of claim 1 wherein fins are provided on said agitator.

3. The mixing apparatus of claim 1 wherein said agitator includes a liquid-tight removable cap.

4. The mixing apparatus of claim 1 wherein water is enclosed in said hollow chamber.

5. The mixing apparatus of claim 1 wherein said agitator is generally spherical in shape.

6. The mixing apparatus of claim 1 wherein said agitator is made of plastic.

7. The mixing apparatus of claim 1 further comprising a removable pack, the removable pack containing thermal material and being sized and shaped to fit in the hollow chamber.

8. The mixing apparatus of claim 1 wherein the agitator is generally tetrahedral in shape.

9. A mixing apparatus comprising:
a shaker cup having a body and a lid;
an agitator comprised of thermally conductive material, the agitator having a hollow chamber therein and having a removable cap for holding thermal material in the hollow chamber in a liquid tight arrangement.

10. The mixing apparatus of claim 9 wherein the agitator includes a neck having threads thereon and the cap has corresponding threads thereon to allow the cap to be screwed to the neck in a liquid tight arrangement.

11. The mixing apparatus of claim 9 wherein the agitator includes fins thereon.

12. The mixing apparatus of claim 9 wherein the agitator is spherical in shape.

13. A method for mixing a liquid comprising the steps of:
selecting a shaker cup having a body and a lid;
selecting an agitator comprised of thermally conductive material, the agitator having a hollow chamber therein and having a removable cap for holding thermal material in the hollow chamber in a liquid tight arrangement;
filling the hollow chamber with a thermal material;
attaching the removable cap to the agitator;
placing the agitator in a colder than ambient temperature for a period of time;
placing a liquid beverage to be mixed in the body of the shaker cup;
placing the agitator in the shaker cup;
sealingly attaching the lid to the shaker cup; and
shaking the shaker cup.

14. The method of claim 13 wherein the step of filling the hollow chamber with a thermal material includes the step of selecting water as thermal material.

15. The method of claim 13 wherein the step of selecting the agitator includes the step of selecting a spherical agitator.

16. The method of claim 13 wherein the step of selecting the agitator includes the step of selecting an agitator having fins thereon.
